(19) United States
(12) Patent Application Publication
(10) Pub. No.: US 2012/0171090 A1
(43) Pub. Date: Jul. 5, 2012

(54) CONTINUOUS TUBULAR FLOW REACTOR AND CORRUGATED REACTOR TUBE FOR THE REACTOR

(75) Inventor: RON-HSIN CHANG, Taichung City (TW)

(73) Assignee: RESI CORPORATION, Taichung City (TW)

(21) Appl. No.: 13/338,676

(22) Filed: Dec. 28, 2011

(30) Foreign Application Priority Data
Dec. 31, 2010 (TW) 99147325

(51) Int. Cl. B01J 8/04

(52) U.S. Cl. 422/641

(57) ABSTRACT

The present invention provides a continuous tubular flow reactor which consists of a reactor tube module having an inlet port and an outlet port, and a pressuring device connected to the inlet port and the outlet of the reactor tube module. The reactor tube module comprises multiple reactor tubes butt connected in sequence. Each reactor tube has alternating straight sections and convergent-divergent sections, wherein inner diameter of the convergent-divergent section is smaller than that of the straight section. The pressuring device has a simple harmonic motion driving device.

### BACKGROUND OF THE INVENTION

1. Field of the Invention

The present invention relates generally to a continuous tubular flow reactor, and more particularly to a continuous tubular flow reactor and a corrugated tube for the reactor, which may provide a highly turbulent mixing condition without a stirring device, and enhance the rate of chemical reaction between liquid/liquid, liquid/gas, and liquid/solid phases.

2. Description of the Related Art

Tubular reactor is widely used for various chemical reactions. Variety kinds of mixing devices, such as static mixer and sharp edged orifice plates, were developed for multi-phase reactions, especially for the reaction of volatile organic compounds, in an elevated pressure and temperature conditions, such as production of biodiesel. Taiwan patent M384866 taught a continuous oscillatory tubular flow reactor for production of biodiesel. The reactor provides a bundle of reactor tubes, with multiple orifice plates be inserted inside each tube, to provide a highly turbulent mixing condition. However, the manufacture and installation of oscillatory flow reactor with orifice plates is relatively difficult and the mechanical structure is complex as well. Furthermore, the existence of orifice plates increases the pressure loss while the fluid flows through the reactor tube. In order to improve the disadvantages of the existing technologies, the present invention provides a bundle of corrugated reactor tubes with a series of smooth convergent-divergent sections to replace the bare tubes with internal orifice plates and consequently provides better mixing and lower pressure drop for fluids flow through the reactor tubes. The present invention may be used in the chemical reactions between liquid/liquid, liquid/gas, and liquid/solid phases.

### SUMMARY OF THE INVENTION

The primary objective of the present invention is to provide a continuous tubular flow reactor, which may provide a highly turbulent mixing condition without mechanical stirring device.

Another objective of the present invention is to provide a corrugated tube for the continuous tubular flow reactor, which provides a series of smooth convergent-divergent sections without dead space and provides extra mixing intensity when liquid flows through the corrugated tube.

According to the objectives mentioned above, the present invention provides a continuous tubular flow reactor which includes a reactor tube module having an inlet port and an outlet port and a pressuring device connected to the inlet and outlet ports of the reactor tube module. The reactor tube module includes multiple reactor tubes butt connected in sequence. Each reactor tube has alternating straight sections and convergent-divergent sections, wherein an inner diameter of the convergent-divergent section is smaller than that of the straight section. The pressuring device has a simple harmonic motion (SHM) driving device for providing the fluid a harmonic reciprocating flow in superposition to the original longitudinal flow. The present invention may provide a highly turbulent mixing condition without mechanical stirring device and enhance the rate of chemical reaction between liquid/liquid, liquid/gas, and liquid/solid phases.

### BRIEF DESCRIPTION OF THE DRAWINGS

FIG. 1 is a perspective view of a preferred embodiment of the present invention;

FIG. 2 is a sectional view of the corrugated tube of the preferred embodiment of the present invention;

FIG. 3 is a perspective view of the preferred embodiment of the present invention, showing the reactor of single reactor tube module;

FIG. 4 is a perspective view of the SHM driving device of the preferred embodiment of the present invention;

FIG. 5 is a perspective view of the preferred embodiment of the present invention, showing the integrated reactor of two reactor tube modules; and

FIG. 6 is a perspective view of the preferred embodiment of the present invention, showing the integrated reactor of four reactor tube modules.

### DETAILED DESCRIPTION OF THE INVENTION

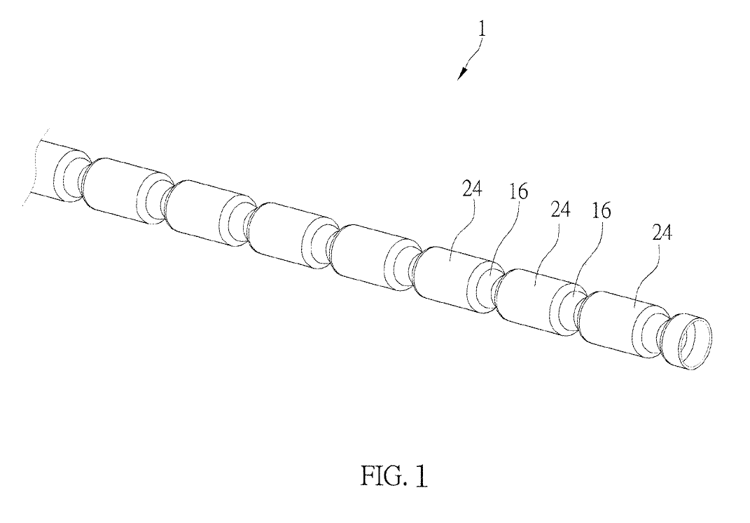

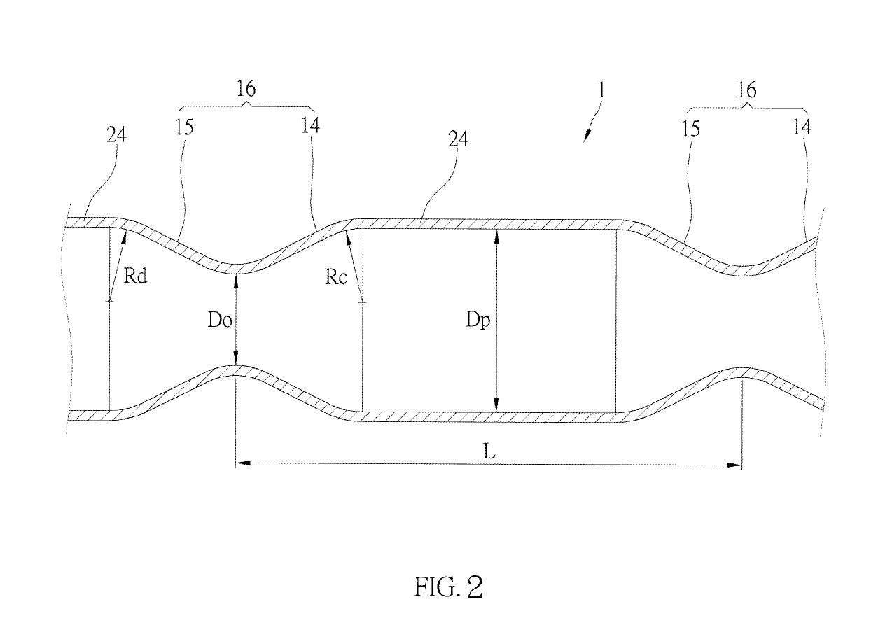

As shown in FIG. 1 and FIG. 2, a continuous tubular flow reactor of the preferred embodiment of the present invention includes a bundle of reactor tubes 1. The reactor tubes 1 may be made of metal, plastic, or glass. The reactor tube 1 has alternating straight sections 24 and convergent-divergent sections 16, wherein an inner diameter of the straight section 24 is larger than that of the convergent-divergent section 16. Each convergent-divergent section 16 consists of a convergent section 14 and a divergent subsection 15. The convergent subsection 14 has a gradually reducing inner diameter, and the divergent subsection 15 has a gradually increasing inner diameter. The inner diameter (Do) at a junction of the convergent subsection 14 and the divergent subsection 15 is shortest. The convergent subsection 14 and the divergent subsection 15 respectively have a curved sidewall, and they respectively have a radius of curvature (Rc represents the radius of curvature of the sidewall of the convergent subsection 14, and Rd represents the radius of curvature of the sidewall of the divergent subsection 15).

In order to obtain the best mixing condition, the reactor tube 1 of the present invention shall fulfill the following conditions:

1. A distance (L) between two neighboring convergent subsections 14 is 1 to 3 times of the inner diameter (Dp) of the straight section 24. That is L/Dp=1-3.

2. The shortest diameter (Do) of the convergent-divergent section 16 is one third to two third of the inner diameter (Dp) of the straight section 24. That is Do/Dp=⅓-⅔.

3. The radius of curvature (Rc) of the sidewall of the convergent subsection 14 is one sixth to one half of the inner diameter (Dp) of the straight section 24. That is Rc/Dp=⅙-½.

4. The radius of curvature (Rd) of the sidewall of the divergent subsection 15 is one sixth to one half of the inner diameter (Dp) of the straight section 24. That is Rd/Dp=⅙-½.

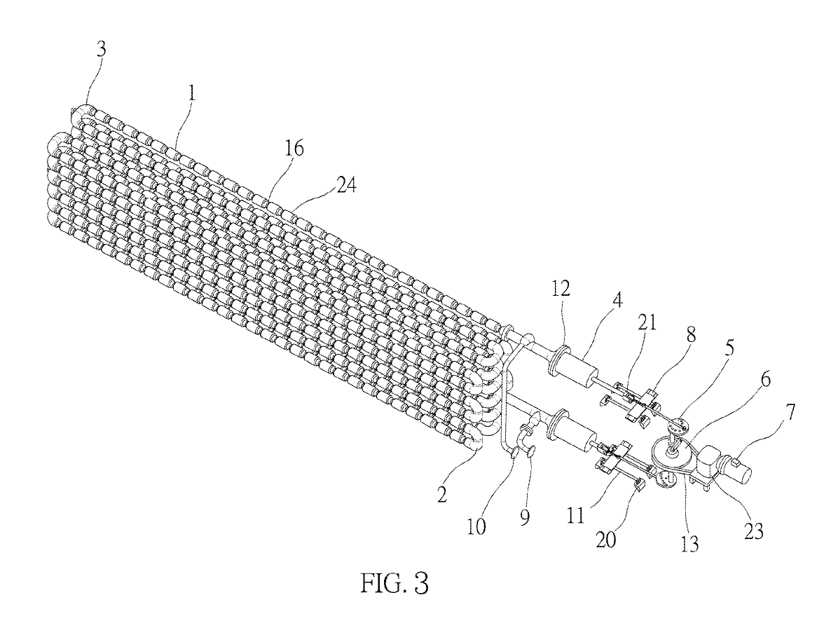

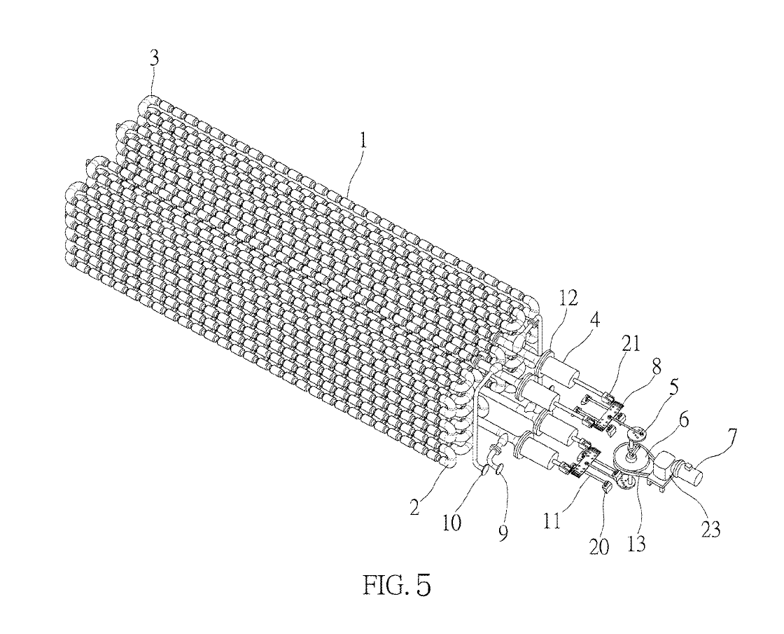

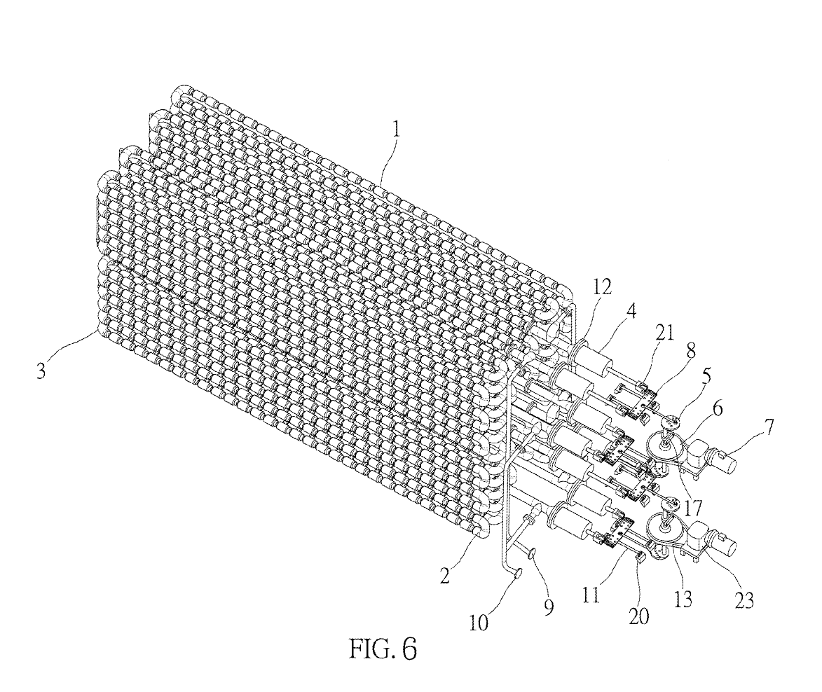

The reactor tube 1 may be incorporated in an oscillatory continuous tubular flow reactor. FIG. 3 shows an oscillatory continuous tubular flow reactor having single reactor tube module, FIG. 5 shows an oscillatory continuous tubular flow reactor having two reactor tube modules, and FIG. 6 shows an oscillatory continuous tubular flow reactor having four reactor tube modules. The numbers, size, and length of the reactor tubes 1 are designated according to the specification of the continuous tubular flow reactor.

FIG. 3 shows the oscillatory continuous tubular flow reactor having one reactor tube module. The reactor tube module consists of N×M reactor tubes 1, wherein N may be any positive integer, and M may be any even integer. In the present embodiment, N=4 and M=6.

The reactor tubes 1 are butt connected in sequence by U tubes 2 and 3. They may be connected together by welding, union connections, or flanges. Each corrugated reactor tube 1 has alternating straight sections 24 and convergent-divergent sections 16, and each convergent-divergent section 16 has a convergent subsection 14 and a divergent subsection 15. Fluid is pumped to flow through the reactor tube 1 and a longitudinal oscillatory simple harmonic motion (SHM) is imposed to the fluid by a pressuring device 8. Because of the longitudinal oscillatory SHM of the fluid and the effects of the periodic changes of the sectional area of the corrugated reactor tube 1, a highly turbulent mixing condition is created which enhances the chemical reaction to be occurred in the reactor tube 1.

It will obtain the optimum turbulent mixing condition while the distance (L) between two neighboring convergent subsections 14 is one (1) to three (3) times of the inner diameter (Dp) of the straight section 24, and more preferable is 1 to 2 times. That is L/Dp=1-3, and more preferable is L/Dp=1-2.

It will obtain the optimum turbulent mixing condition while the radius of curvature (Rc) of the sidewall of the convergent subsection 14 is one fifth to one half of the inner diameter (Dp) of the straight section 24, that is Rc/Dp=⅕-½, and more preferable is one fourth (¼).

It will obtain the optimum turbulent mixing condition while the radius of curvature (Rd) of the sidewall of the divergent subsection 15 is one fifth to one half of the inner diameter (Dp) of the straight section 24, that is Rd/Dp=⅕-½, and more preferable is one fourth (¼).

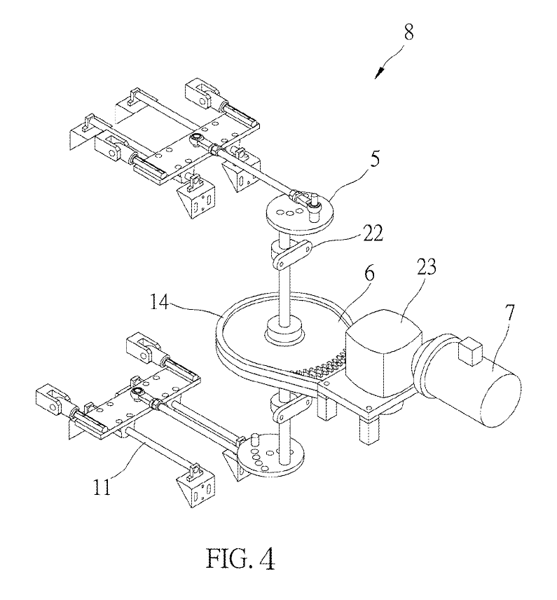

As shown in FIG. 3, the reactor tube module has an inlet port 9 at an end of the first reactor tube 1 and an outlet port 10 an end of the last reactor tube 1. Both of the inlet port 9 and the outlet port 10 are respectively connected to a pressuring device 8 through a reducer coupling 12 and a piston 4. As shown in FIG. 4, the pressuring device 8 includes a simple harmonic motion (SHM) driving device. The SHM driving device consists of an inverter motor 7 to drive an amplitude adjusting disk 5 through a reduction gear box 23, a chain 13, and a chain wheel 6 to transform a rotary motion into a reciprocating motion. The amplitude adjusting disk 5 may drive the piston 4 through a linkage 21 and provide the piston 4 a reciprocating motion. Consequently, the pressuring device 8 may provide the liquid in the reactor tube 1 an oscillatory reciprocating pressure. The pressuring device 8 works with the corrugated reactor tube module to provide a highly turbulent mixing condition.

The SHM driving device drives the linkage 11 for a SHM motion through a ball bearing, and the linkage 11 has opposite ends fixed to a frame by two adjusting frames 20. The amplitude adjusting disk 5 may be set to make the pistons 4 at the inlet port 9 and the outlet port 10 moving in opposite directions whence the resistance of the liquid flows in the reactor tubes 1 may be minimized. The speed may be adjusted by the reduction gear box 23 and the chain wheel 6, and the stroke may be adjusted by the amplitude adjusting disk 5 that any size of the reactor may use the same amplitude adjusting disk 5 for standardization.

As shown in FIG. 4, the SHM driving device provides the inverter motor 7 to drive the amplitude adjusting disk 5 through the reduction gear box 23, the chain 13, and the chain wheel 6 to transform a rotary motion into a reciprocating motion. The amplitude adjusting disk 5 may drive the piston 4 through the linkage 21 and provide the piston 4 a reciprocating motion. The linkage 21 has two universal joints at opposite ends to be pivoted on the amplitude adjusting disk 5 and the piston 4. Consequently, the pressuring device 8 may provide the liquid in the reactor tube 1 an oscillatory reciprocating pressure. The pressuring device 8 works with the corrugated reactor tube module to provide a highly turbulent mixing condition.

The amplitude and frequency of the SHM driving device of the pressuring device 8 must be adjusted to fulfill the specification of the reactor tubes 1 to obtain the best turbulent mixing condition. Experimental results shows that the frequency and amplitude of SHM is close related to Reynolds number of liquid flowing through the reactor tubes 1.

For liquid flows through the straight sections 24 of the reactor tubes 1, the Reynolds number (Ren) may be calculated by the following equation:

Ren=Dp*u*ρ/μ

where:
Dp: the inner diameter of the straight sections 24 of the reactor tubes 1;
u: superficial flow rate of the liquid in the straight sections 24 of the reactor tubes 1;
ρ: density of liquid; and
μ: viscosity of liquid.

When liquid flows through the reactor tubes 1 in SHM, the Oscillatory Reynolds number (Reo) may be defined by the following equation:

Reo=2*Dp*π*f*δ*ρ/μ

where:
Dp: the inner diameter of the straight sections 24 of the reactor tubes 1;
f: frequency of SHM;
δ: amplitude of SHM;
ρ: density of liquid; and
μ: viscosity of liquid.

Experimental results shows that the best turbulent mixing condition will be obtained when Reo is 1.2 to 3 times of Ren, that is Reo/Ren=1.2-3.0, and more preferable, Reo/Ren=1.5-2.0.

The continuous tubular flow reactor equipped with the corrugated reactor tubes of the present invention may provide a better turbulent mixing condition than the conventional reactor, and may increase the rate of reaction under a high temperature and high pressure condition. It also may increase reaction yield and conversion rate, or reduce the reactor volume required. The present invention may be used in the reactions between liquid/liquid, liquid/gas, and liquid/solid phases.

FIG. 5 shows a continuous tubular flow reactor of double reactor tube modules, in which each reactor tube module consists of N×M corrugated reactor tubes 1, wherein N may be any positive integer, and M must be any even positive integer. In the present embodiment, N=4 and M=6. The reactor tubes 1 are butt connected in sequence by U tubes 2 and 3, or by welding, union connections or flanges.

Each reactor tube 1 has alternating straight sections 24 and convergent-divergent sections 16, and each convergent-divergent section 16 has a convergent subsection 14 and an divergent subsection 15. The characteristics of the convergent-divergent section 16 and the reactor tubes 1 are the same as mentioned above.

As shown in FIG. 5, the reactor tube module has an inlet port 9 at the entrance end of the first reactor tube 1 and an outlet port 10 at the outlet end of the last reactor tube 1. Both of the inlet port 9 and the outlet port 10 are respectively connected to the SHM driving device through a reducer coupling 12 and a piston 4.

FIG. 6 shows a continuous tubular reactor of multiple reactor tube modules, in which four reactor tube modules are provided, and each reactor tube module consists of N×M corrugated reactor tubes 1, wherein N may be any positive integer, and M may be any even positive integer. In the present embodiment, N=4 and M=6. The reactor tubes 1 are butt connected in sequence by U tubes 2 and 3, or by welding, union connections or flanges. The characteristics of the convergent-divergent section 16 and the reactor tubes 1 are the same as mentioned above.

As shown in FIG. 6, the reactor tube module has an inlet port 9 at the entrance end of the first reactor tube 1 and an outlet port 10 at the outlet end of the last reactor tube 1. Both of the inlet port 9 and the outlet port 10 are respectively connected to the SHM driving device through a reducer coupling 12 and a piston 4.

Another feature of the present invention is that when the speed of the inverter motor 7 is reduced by the reduction gear box 23 and the chain 13, the amplitude of SHM or the stroke of the piston 4 may be adjusted easily by the amplitude adjusting disk 5. Any size of the reactor may use the same amplitude adjusting disk 5 for standardization.

The conventional stirred tank reactor always has the problems of uneven mixing intensity, high power consumption, and danger in VOC emissions for a chemical reaction with volatile components. The present invention may overcome the disadvantages of the conventional stirred tank reactor by utilizing the corrugated reactor tubes 1, the pistons 4 and the SHM driving device to produce micro mixing of the liquid in the reactor tubes 1 and hence to enhance the turbulent mixing intensity between liquid/liquid, liquid/gas, and liquid/solid phases and increase the chemical reaction accordingly.

When the oscillatory continuous tubular flow reactor of the present invention is used in the reaction between volatile liquid/liquid, it may restrict the liquid in the reactor tubes and keeping the reaction going under an elevated temperature and pressure condition to avoid the emission of volatile gas and provide a safe operation of the reactor.

The description above is a few preferred embodiments of the present invention and the equivalence of the present invention is still in the scope of claim construction of the present invention.

What is claimed is:

1. A continuous tubular flow reactor, comprising:
a reactor tube module having an inlet port and an outlet port, wherein the reactor tube module includes multiple reactor tubes butt connected in sequence, and each of the reactor tubes has alternating straight sections and convergent-divergent sections, and an inner diameter of the convergent-divergent section is smaller than that of the straight section; and
a pressuring device connected to the inlet port of the reactor tube module to pressurize and send a reactant into the reactor tube module.

2. The continuous tubular flow reactor as defined in claim 1, wherein a distance between two neighboring convergent-divergent sections is 1 to 3 times of the inner diameter of the straight section.

3. The continuous tubular flow reactor as defined in claim 1, wherein the convergent-divergent section has a convergent subsection with a generally reducing inner diameter and a divergent subsection with a generally increasing inner diameter.

4. The continuous tubular flow reactor as defined in claim 1, wherein the convergent-divergent section has a shortest diameter which is one third to two third of the inner diameter of the straight section.

5. The continuous tubular flow reactor as defined in claim 3, wherein a radius of curvature of a sidewall of the convergent subsection is one sixth to one half of the inner diameter of the straight section.

6. The continuous tubular flow reactor as defined in claim 3, wherein a radius of curvature of a sidewall of the divergent subsection is one sixth to one half of the inner diameter of the straight section.

7. The continuous tubular flow reactor as defined in claim 1, wherein the pressuring device has a simple harmonic motion driving device to move the liquid in the reactor tubes forward and backward periodically.

8. The continuous tubular flow reactor as defined in claim 7, further comprising a piston connected to the inlet port of the reactor tube module, wherein the simple harmonic motion driving device is connected to the piston to drive the piston.

9. The continuous tubular flow reactor as defined in claim 1, wherein the pressuring device has two simple harmonic motion driving devices connected to the inlet port and the outlet port of the reactor tube module to move the liquid in the reactor tubes forward and backward periodically.

10. The continuous tubular flow reactor as defined in claim 9, further comprising two pistons respectively connected to the inlet port and the outlet port of the reactor tube module, wherein the simple harmonic motion driving devices are respectively connected to the piston to drive the piston.

11. The continuous tubular flow reactor as defined in claim 7, wherein the simple harmonic motion driving device includes an inverter motor to drive an amplitude adjusting disk through a reduction gear box and a chain wheel to transform a rotary motion into a reciprocating motion.

12. The continuous tubular flow reactor as defined in claim 11, wherein the simple harmonic motion driving device further includes a chain to connect the reduction gear box and the chain wheel.

13. The continuous tubular flow reactor as defined in claim 8, further comprising a linkage to connect the piston and the simple harmonic motion driving device.

14. The continuous tubular flow reactor as defined in claim 13, wherein the linkage has two universal joints at opposite ends to be pivoted on the amplitude adjusting disk and the piston.

15. A reactor tube for a continuous tubular flow reactor, having alternating straight sections and convergent-divergent sections, wherein the convergent-divergent section has a shortest diameter which is one third to two third of an inner diameter of the straight section.

16. The reactor tube as defined in claim 15, wherein a distance between two neighboring convergent subsections is 1 to 3 times of the inner diameter of the straight section.

17. The reactor tube as defined in claim 15, wherein the convergent-divergent section has a convergent subsection with a generally reducing inner diameter and a divergent subsection with a generally increasing inner diameter.

18. The reactor tube as defined in claim 17, wherein a radius of curvature of a sidewall of the convergent subsection is one sixth to one half of the inner diameter of the straight section.

19. The reactor tube as defined in claim 17, wherein a radius of curvature of a sidewall of the divergent subsection is one sixth to one half of the inner diameter of the straight section.
